(19) United States
(12) Patent Application Publication
(10) Pub. No.: US 2025/0051221 A1
(43) Pub. Date: Feb. 13, 2025

(54) CERAMIC PRODUCT AND DECORATIVE COMPOSITION

(71) Applicant: NORITAKE CO., LIMITED, Nagoya-shi (JP)

(72) Inventors: Yukiko Kikugawa, Nagoya-shi (JP); Yoshihide Maeno, Nagoya-Shi (JP); Yoshihiro Suzuki, Nagoya-shi (JP)

(21) Appl. No.: 18/686,911

(22) PCT Filed: Jul. 27, 2022
(86) PCT No.: PCT/JP2022/028995

§ 371 Date: Feb. 27, 2024

(30) Foreign Application Priority Data
Aug. 30, 2021 (JP) 2021-140390

(51) Int. Cl. C03C 8/18; C03C 8/02; C03C 10/00; C04B 33/24; C04B 41/50

(52) U.S. Cl. CPC C03C 8/18; C03C 8/02; C03C 10/00; C04B 33/24; C04B 41/5023; C03C 2204/00; C03C 2209/00

(57) ABSTRACT

According to the present invention, there is provided a ceramic product in which damage to a decorative film during washing with an alkali can be reduced. In a ceramic product 1 disclosed here, a decorative film 30 is formed on the surface of a ceramic substrate 10. Here, the decorative film 30 of the ceramic product includes a noble metal region 32 containing a noble metal element as a main component and an amorphous region 34 containing matrix-forming elements containing at least Si as a main component. Here, in the ceramic product 1 disclosed here, crystalline particles 35 containing a crystalline oxide of at least one metal element selected from among the matrix-forming elements as a main component are dispersed in the amorphous region 34. Since such crystalline particles 35 are difficult for alkaline components to penetrate, it is possible to prevent the alkaline components from entering the amorphous region 35 and reduce damage to the decorative film 30 during washing with an alkali.

### TECHNICAL FIELD

The present invention relates to a ceramic product and a decorative composition. Specifically, the present invention relates to a ceramic product in which a decorative film is formed on the surface of a ceramic substrate and a decorative composition that forms a decorative film of the ceramic product. Here, priority is claimed on Japanese Patent Application No. 2021-140390, filed Aug. 30, 2021, the content of which is incorporated herein by reference.

### BACKGROUND ART

A decorative film for imparting an elegant or luxurious impression is sometimes formed on the surface of ceramic products such as ceramicware, glassware, and enamelware. This type of decorative film includes, for example, a noble metal region containing a noble metal element, and an amorphous region for fixing the noble metal region. Such an amorphous region has, for example, an amorphous matrix (typically a glass matrix) having a framework of an oxide of predetermined metal elements or semi-metal elements (matrix-forming elements). Here, a decorative film having such a structure is formed by firing a paste-like decorative composition. Such a decorative composition includes, for example, a compound of a noble metal element and an organic substance (hereinafter referred to as a “noble metal organic compound”) and a compound of a matrix-forming element and an organic substance (hereinafter referred to as a “matrix-forming metal-organic compound”).

Incidentally, in ceramic products including a decorative film having the above structure, there is a need for a technique for reducing damage (peeling, cracking, etc.) to the decorative film during washing. Specifically, since the amorphous matrix that forms the amorphous region of the decorative film has poor chemical resistance, it may be damaged when washed (for example, washed using an automatic dishwasher) in a high temperature environment in which a strong alkaline detergent is used. Various techniques have been proposed in the past in order to reduce such damage to the decorative film during washing with an alkali. For example, Patent Literature 1 discloses that, when an indium metal organic compound is added to a decorative composition containing a metal organic compound (a gold liquid for forming an alkali-resistant decorative gold coating), it is possible to improve the alkali resistance of the decorative film after firing.

### CITATION LIST

### Patent Literature

Patent Literature 1: Japanese Patent Application Publication No. H11-6072

### SUMMARY OF INVENTION

### Technical Problem

However, in recent years, there has been a need for development of a technique that can better reduce damage to decorative films during washing with an alkali. For example, in recent years, decorative films with a reduced content of noble metal elements have been formed in ceramic products in order to reduce costs and make them compatible with microwave ovens. A decorative film of this type containing a small amount of noble metal element tends to easily peel off during washing with an alkali because the exposed amount of the amorphous region having low alkali resistance increases.

The present invention has been made in view of the above circumstances, and an object of the present invention is to provide a ceramic product in which damage to a decorative film during washing with an alkali can be reduced.

### Solution to Problem

In order to solve the above problems, a ceramic product having the following structure is provided.

In the ceramic product disclosed here comprises a ceramic substrate and a decorative film is formed on the surface of the ceramic substrate. Here, the decorative film of the ceramic product includes a noble metal region containing a noble metal element as a main component and an amorphous region containing matrix-forming elements containing at least Si as a main component. Here, in the ceramic product disclosed here, in the amorphous region, crystalline particles containing a crystalline oxide of at least one metal element selected from among the matrix-forming elements as a main component are dispersed.

In the ceramic product including a decorative film having the above structure, crystalline particles containing a crystalline oxide as a main component are dispersed in the amorphous region. Since it is difficult for alkaline components to structurally penetrate such crystalline particles, it is possible to prevent the alkaline components from entering the amorphous region. Therefore, it is possible to reduce damage to the decorative film during washing with an alkali.

In one preferable aspect of the ceramic product disclosed here, the matrix-forming elements include at least one selected from the group consisting of Al, Ti, Zr, Bi, Sm, Y, La, Ce, Pr, Nd, Sm, Dy, Sn, Zn, Be, Mg, Ca, Sr, Ba, Li, Na, K, Rb, B, V, Fe, Cu, P, Sc, Pm, Eu, Gd, Tb, Ho, Er, Tm, Yb, Lu, Ni, In, Co, and Cr. Therefore, it is possible to form a decorative film including an amorphous region having excellent chemical resistance and fixability.

In one preferable aspect of the ceramic product disclosed here, the crystalline particles contain, as a main component, a crystalline oxide of a metal cation having an ion potential of 2.5 or more and 12 or less, which is obtained by dividing an ionic charge by an ionic radius. A crystalline oxide of a metal cation having an ion potential of 2.5 or more has a characteristic of a strong bond with oxygen atoms and high water resistance. On the other hand, the crystalline oxide of a metal cation having an ion potential of 12 or less has high alkali resistance because it has low reactivity with an alkali. When crystalline particles are formed of this type of crystalline oxide, it is possible to obtain a decorative film that achieves both alkali resistance and water resistance at a high level. Here, as an example of this type of crystalline oxide, a crystalline oxide containing Zr and/or Ti may be exemplified.

In one preferable aspect of the ceramic product disclosed here, the noble metal element is at least one selected from the group consisting of Pt, Au, Pd, Rh, Ir, and Ag. These noble metal elements can contribute to the formation of a decorative film having excellent aesthetic properties.

In one preferable aspect of the ceramic product disclosed here, the decorative film is formed by scattering a plurality of noble metal regions in the amorphous region. In the decorative film having such a structure, since each noble metal region is insulated by the amorphous region, it is possible to prevent damage due to sparks when using a microwave oven. On the other hand, in the microwaveable ceramic product having such a structure, since the exposed amount of the amorphous region having poor alkali resistance increases, the decorative film tends to easily peel off during washing with an alkali. However, in the ceramic product disclosed here, since crystalline particles can prevent alkaline components from entering the amorphous region, even with this type of microwaveable ceramic product, it is suitably possible to prevent the decorative film from peeling off.

In addition, according to another aspect of the technology disclosed here, there is provided a decorative composition for forming a ceramic product including a decorative film having the above structure. Such a decorative composition includes a noble metal organic compound that is a compound of a noble metal element and an organic substance and a matrix-forming metal-organic compound that is a compound of a matrix-forming element and an organic substance. The matrix-forming metal-organic compounds include a Si organic compound that is a compound of at least Si and an organic substance and a crystal-forming organic compound that is a compound of a crystal-forming element with a single bond strength of less than 339 kJ/mol when an oxide is formed and an organic substance. Here, in the decorative composition disclosed here, the relationship between the burning temperature T_{Si} of the Si organic compound and the burning temperature T_{X} of the crystal-forming organic compound satisfies the following Formula (1).

T_{X}<T_{Si} (1)

In the decorative composition disclosed here, the burning temperature T_{X} of the crystal-forming organic compound is lower than the burning temperature T_{Si} of the Si organic compound (T_{X}<T_{Si}). When such a decorative composition is fired, the crystal-forming organic compound is preferentially decomposed and fired. Here, since the oxide of the crystal-forming element produced during the firing treatment has a single bond strength of less than 339 kJ/mol, it cannot independently form an amorphous matrix framework and becomes crystalline particles. Thereafter, since the Si organic compound is decomposed and fired to form an amorphous matrix framework of an amorphous region, it is possible to form a decorative film in which crystalline particles are dispersed in an amorphous region.

In one preferable aspect of the decorative composition disclosed here, the matrix-forming metal-organic compound further includes an Al organic compound that is a compound of Al and an organic substance. When such a decorative composition is fired, an amorphous region containing aluminosilicate glass, which contains a composite oxide containing Si and Al as an amorphous matrix framework, is formed. According to the technology disclosed here, even if such an amorphous region containing aluminosilicate glass is formed, it is possible to prevent the decorative film from peeling off during washing with an alkali. Here, in order to form an amorphous region containing aluminosilicate glass more appropriately, a total content of Si and Al based on 100 mol % of a total number of moles of noble metal elements and matrix-forming elements is preferably 5 mol % or more and 60 mol % or less. In addition, the content of Si based on 100 mol % of a total number of moles of Si and Al is preferably 40 mol % or more and 99.5 mol % or less.

In one preferable aspect of the decorative composition disclosed here, the content of the noble metal element based on 100 mol % of a total number of moles of noble metal elements and matrix-forming elements is 25 mol % or more and 85 mol % or less. Therefore, it is possible to form a decorative film in which both color development and gloss are achieved at a high level.

In one preferable aspect of the decorative composition disclosed here, the matrix-forming metal-organic compound further includes a Bi organic compound that is a compound of Bi and an organic substance. When such a decorative composition is fired, bismuth oxide (Bi₂O₃) is included in a part of the matrix framework of the amorphous region. Therefore, since fixability of the decorative film to the substrate is improved, it is more suitably possible to prevent damage to decorative film (particularly, peeling off) during washing with an alkali. Here, in order to appropriately form an amorphous region containing Bi₂O₃, the content of Bi based on 100 mol % of a total number of moles of matrix-forming elements is preferably 5 mol % or more and 30 mol % or less.

In one preferable aspect of the decorative composition disclosed here, the content of the crystal-forming element based on 100 mol % of a total number of moles of the matrix-forming element is 3 mol % or more and 60 mol % or less. Therefore, since the amorphous region and the crystalline particles are formed in a well-balanced manner, it is possible to obtain a decorative film in which alkali resistance and gloss are achieved at a high level.

In one preferable aspect of the decorative composition disclosed here, the crystal-forming element is at least one selected from the group consisting of Zr and Ti. As described above, since crystalline particles containing Zr and Ti have a property of barely dissolving in an alkaline solution, it is more suitably possible to prevent the decorative film from peeling off during washing with an alkali.

In addition, the decorative film of the ceramic product disclosed here can be formed using a decorative composition having a structure different from that of the above composition. Such a decorative composition includes a noble metal organic compound that is a compound of a noble metal element and an organic substance and a matrix-forming metal-organic compound that is a compound of a matrix-forming element and an organic substance, and the matrix-forming metal-organic compounds include at least a Si organic compound that is a compound of Si and an organic substance. Here, in the decorative composition, crystalline particles containing a crystalline oxide of at least one metal element selected from among the matrix-forming elements as a main component are dispersed.

In the decorative composition having the above structure, crystalline particles formed in advance are dispersed in the decorative composition. When such a decorative composition is fired, since the Si organic compound is decomposed and fired in the presence of crystalline particles to form an amorphous matrix framework, it is possible to form a decorative film in which crystalline particles are dispersed in an amorphous region.

### BRIEF DESCRIPTION OF DRAWINGS

FIG. 1 is a diagram schematically showing a cross-sectional structure of a ceramic product according to one embodiment.

FIG. 2 is a cross-sectional TEM image of a decorative film of Example 4.

FIG. 3 is an XRD chart of a decorative film of Example 1.

FIG. 4 is an XRD chart of a decorative film of Example 2.

FIG. 5 is an XRD chart of a decorative film of Example 3.

FIG. 6 is an XRD chart of a decorative film of Example 4.

FIG. 7 is an XRD chart of a decorative film of Example 5.

FIG. 8 is an XRD chart of a decorative film of Example 6.

FIG. 9 is an XRD chart of a decorative film of Example 7.

FIG. 10 is an XRD chart of a decorative film of Example 8.

FIG. 11 is an XRD chart of a decorative film of Example 9.

FIG. 12 is an XRD chart of a decorative film of Example 10.

FIG. 13 is an XRD chart of a decorative film of Example 11.

FIG. 14 is an XRD chart of a decorative film of Example 12.

FIG. 15 is an XRD chart of a decorative film of Example 13.

FIG. 16 is an XRD chart of a decorative film of Example 14.

FIG. 17 is an XRD chart of a decorative film of Example 15.

FIG. 18 is an XRD chart of a decorative film of Example 16.

FIG. 19 is an XRD chart of a decorative film of Example 17.

FIG. 20 is an XRD chart of a decorative film of Example 18.

FIG. 21 is an XRD chart of a decorative film of Example 19.

FIG. 22 is an XRD chart of a decorative film of Example 20.

FIG. 23 is an XRD chart of a decorative film of Example 21.

FIG. 24 is an XRD chart of a decorative film of Example 22.

FIG. 25 is an example of a histogram with a horizontal axis that represents a brightness value of a secondary electron image of a cut surface of a ceramic product and with a vertical axis that represents a count number.

### DESCRIPTION OF EMBODIMENTS

Preferable embodiments of the technology disclosed here will be described below. Here, components other than those particularly mentioned in this specification that are necessary for implementation (for example, a detailed preparation method of a decorative composition and a ceramic substrate production procedure) can be understood based on the technical content taught in this specification and general common general technical knowledge of those skilled in the art in the field. The content of the technology disclosed here can be implemented based on the content disclosed in this specification and common general technical knowledge in the field. Here, the notation “A to B” indicating a range in this specification means A or more and B or less. Therefore, it includes a range exceeding A but below B.

### <Ceramic Product>

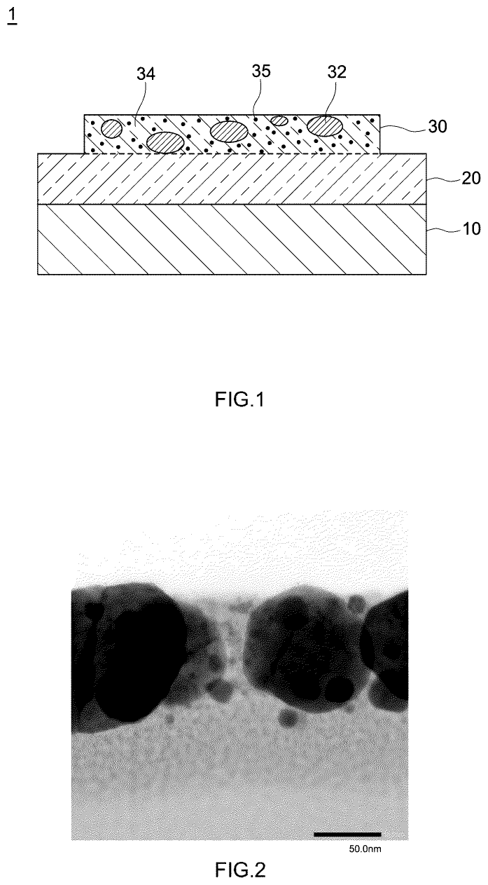

One embodiment of the ceramic product disclosed here will be described below. FIG. 1 is a diagram schematically showing a cross-sectional structure of a ceramic product according to the present embodiment. Here, the sizes (a length, a width, a thickness, etc.) in FIG. 1 do not reflect actual sizes. As shown in FIG. 1, a ceramic product 1 includes a substrate 10, a coat layer 20, and a decorative film 30. Respective components will be described below.

### 1. Substrate

The substrate 10 is a molded product mainly composed of ceramics. Examples of ceramics for the substrate 10 include silica, alumina, zirconia, ceria, yttria, boronia, magnesia, and calcia. Here, the thickness, shape, color, hardness and the like of the substrate 10 can be appropriately changed depending on applications of the ceramic product 1, and are not intended to limit the technology disclosed here, and thus detailed description will be omitted.

### 2. Coat Layer

In the ceramic product 1 according to the present embodiment, the coat layer 20 is formed on the surface of the substrate 10. The coat layer 20 is a layer mainly composed of glass, and is formed to protect the substrate 10 and improve aesthetic properties (particularly, gloss). The coat layer 20 is formed by applying an agent (glaze) containing a matrix-forming element to be described below to the surface of the substrate 10 and then firing it. Here, the composition of the coat layer 20 is not particularly limited as long as the effects of the technology disclosed here are not significantly impaired, and conventionally known components that can be used in a protective layer of a ceramic substrate can be appropriately selected. As an example, the coat layer 20 may include Si, Al, Fe, Mg, Na, Zn, K, Ca, Sn and the like as substantial constituent elements. Here, these constituent elements can construct a matrix in the form of an amorphous oxide. That is, in the coat layer 20, an amorphous matrix containing silicon oxide (SiO₂), aluminum oxide (Al₂O₃), iron oxide (Fe₂O₃), magnesium oxide (MgO), potassium oxide (Na₂O), zinc oxide (ZnO), potassium oxide (K₂O), calcium oxide (CaO), tin oxide (SnO₂) or the like can be constructed. Here, the abundance ratio of each element in the coat layer 20 does not limit the technology disclosed here, and thus detailed description will be omitted.

### 3. Decorative Film

As shown in FIG. 1, the ceramic product 1 according to the present embodiment has the decorative film 30. Such a decorative film 30 is formed on the surface of the coat layer 20. Although not shown, the decorative film 30 is generally formed to exhibit a desired pattern (including letters and pictures) in a plan view in order to improve aesthetic properties of the ceramic product 1. Here, the thickness of the decorative film 30 is preferably 30 nm or more and 250 nm or less. The ceramic product 1 on which such a thin decorative film 30 is formed exhibits excellent aesthetic properties at low cost, but aesthetic properties may be significantly impaired when the decorative film 30 is slightly peeled off. Although details will be described below, the technology disclosed here can prevent the decorative film 30 from being peeled off during washing with an alkali, and is therefore particularly preferable for the ceramic product 1 having the thin decorative film 30 as described above.

Here, as shown in FIG. 1, in the decorative film 30 in the present embodiment, a noble metal region 32, an amorphous region 34, and crystalline particles 35 are formed.

### (1) Noble Metal Region

The noble metal region 32 is a region containing a noble metal element as a main component. The noble metal region 32 mainly contributes to coloring the decorative film 30. Examples of noble metal elements contained in the noble metal region 32 include platinum (Pt), gold (Au), palladium (Pd), rhodium (Rh), iridium (Ir), silver (Ag), ruthenium (Ru), and osmium (Os). Here, the noble metal region 32 may contain an element other than noble metal elements. For example, the noble metal region 32 may contain some of matrix-forming elements to be described below and non-metal elements such as carbon (C) and oxygen (O).

Here, in this specification, “the noble metal region containing a noble metal element as a main component” is a region with the highest brightness at the peak of a histogram obtained by performing image analysis on a cross section of a ceramic product. In such image analysis, first, the ceramic product is cut in the thickness direction of the decorative film, and the cut surface is fixed according to a resin embedding treatment and then polished by ion milling. Next, when the sample is fixed on the sample stand with a carbon tape so that the polished surface faces upward, coating is performed using an osmium plasma coater (OPC80N, commercially available from Japan Laser Corporation), and a measurement sample whose cut surface is coated with osmium is produced. Here, the discharge voltage for osmium coating is 1.2 kV, the degree of vacuum is 6 to 8 Pa, and the coating time is 10 seconds. Next, using a field emission scanning electron microscope (SU8230, commercially available from Hitachi High-Tech Corporation), a secondary electron image of the cut surface of the decorative film is acquired. Here, the acceleration voltage for acquiring a secondary electron image is 2.0 kV, the emission current is 10±0.5 μA, and the field of view is 50,000× to 100,000×. Next, the acquired secondary electron image is subjected to noise removal by setting sigma=2 to 5 with a Gaussian filter using the image processing software image J (ver. 1.53e). In this specification, a region with a brightness value of 125 or more in the image after noise removal is regarded as a “noble metal region containing a noble metal element as a main component”. Here, when a histogram with a horizontal axis that represents the brightness value of the noise-removed image and with a vertical axis that represents the count number is created, four peaks with different brightnesses are observed (refer to FIG. 25). Here, these four peaks correspond to four regions including the embedding resin, the substrate, the amorphous region, and the noble metal region in descending order of brightness, and the region with the highest brightness corresponds to the noble metal region. The threshold value (brightness of 125 or more in FIG. 25) for determining whether it is in the noble metal region is set based on such histogram analysis.

In addition, the mass concentration C_{N} of the noble metal element measured in FESEM-EDS analysis of the surface of the decorative film 30 is preferably 11% or more, preferably 11.5% or more, more preferably 12% or more, and particularly preferably 13% or more. Therefore, it is possible to improve chemical resistance (particularly, acid resistance) of the decorative film 30. On the other hand, the upper limit value of the mass concentration C_{N} of the noble metal element is preferably 70% or less, more preferably 69.5% or less, still more preferably 69% or less, and particularly preferably 68% or less. Therefore, this can contribute to reducing production cost and prevent damage to the decorative film 30 when using a microwave oven. In addition, it is possible to prevent the occurrence of fogging in the decorative film due to an excessively large particle size of noble metal particles according to oversintering. Here, in this specification, the “mass concentration” is a relative mass of any metal element (or semi-metal element) based on 100% of “a total mass of metal elements and semi-metal elements” obtained by performing FESEM-EDS (field emission scanning electron microscope-energy dispersive X-ray analysis) on the surface of the decorative film.

Here, as shown in FIG. 1, in the decorative film 30 in the present embodiment, a plurality of noble metal regions 32 are scattered in the amorphous region 34. Therefore, since each noble metal region 32 is insulated by the amorphous region 34, it is possible to prevent the decorative film 30 from being damaged by sparks when using a microwave oven. On the other hand, in this type of microwaveable ceramic product 1, the exposed amount of the amorphous region 34 having poor alkali resistance increases, and thus the decorative film 30 tends to peel off during washing with an alkali. However, in the ceramic product 1 according to the present embodiment, since the crystalline particles 35 to be described below can prevent alkaline components from entering the amorphous region 34, even when the exposed amount of the amorphous region 34 increases, it is possible to appropriately prevent the decorative film 30 from being peeled off during washing with an alkali.

### (2) Amorphous Region

The amorphous region 34 is a region that contributes to fixing and protection of the noble metal region 32, and has an amorphous matrix having a framework of an oxide of predetermined metal elements (matrix-forming elements). Here, in this specification, “matrix-forming element” is a concept that includes a metal element and a semi-metal element that can construct an amorphous matrix in the form of an oxide. In addition, “amorphous matrix” refers to a structure in which an amorphous oxide (an oxide with an amorphous structure) of a predetermined metal element or semi-metal element is formed as a framework and various metal elements (or semi-metal elements) are then present in the framework as an oxide or in the form of cations. As an example of materials (amorphous materials) having such an amorphous matrix, glass may be exemplified. Here, in this specification, “an amorphous region containing a matrix-forming element as a main component” is a region in which the second highest brightness is confirmed in the above image analysis of a cut surface of a ceramic product. Specific examples of matrix-forming elements will be described below.

First, the matrix-forming element in the present embodiment includes at least silicon (Si). Since Si constitutes the amorphous matrix framework in the form of silicon oxide (SiO₂), it is an essential constituent element of the amorphous region 34. In addition, in the FESEM-EDS analysis of the surface of the decorative film 30, the Si mass concentration C_{Si} is preferably 10% or more, more preferably 15% or more, still more preferably 17.5% or more, and particularly preferably 20% or more. Therefore, a strong amorphous matrix having an appropriate framework is formed. On the other hand, in consideration of chemical resistance, fixability and the like, the amorphous region 34 preferably contains a certain amount or more of matrix-forming elements other than Si. In consideration of a possibility of incorporating such matrix-forming elements other than Si, the upper limit of the Si mass concentration C_{Si} is preferably 60% or less, more preferably 59.5% or less, still more preferably 59% or less, and particularly preferably 58.5% or less.

In addition, examples of matrix-forming elements other than Si include Al, Ti, Zr, Bi, Sm, Y, La, Ce, Pr, Nd, Sm, Dy, Sn, Zn, Be, Mg, Ca, Sr, Ba, Li, Na, K, Rb, B, V, Fe, Cu, P, Sc, Pm, Eu, Gd, Tb, Ho, Er, Tm, Yb, Lu, Ni, In, Co, and Cr. It is preferable that these matrix-forming elements other than Si be appropriately included in the amorphous region 34 in consideration of various properties.

For example, as a preferable example of matrix-forming elements other than Si, aluminum (Al) may be exemplified. Al has a function of forming a composite oxide with other matrix-forming elements (Si, etc.) and improving chemical resistance (alkali resistance and/or acid resistance) of the amorphous region 34. Here, although the technology disclosed here is not limited, in order to suitably improve chemical resistance of the amorphous region 34, the Al mass concentration C_{Al} in FESEM-EDS analysis of the surface of the decorative film 30 is preferably 1% or more, more preferably 1.5% or more, still more preferably 2% or more, and particularly preferably 2.5% or more. On the other hand, in consideration of a possibility of incorporating other matrix-forming elements, the upper limit of the Al mass concentration C_{Al} is preferably 15% or less, more preferably 14% or less, still more preferably 13.5% or less, and particularly preferably 13% or less.

In addition, other preferable examples of matrix-forming elements other than Si include zirconium (Zr) and titanium (Ti). These can also contribute to improving chemical resistance of the amorphous region 34. Although there is no intention to limit the technology disclosed here, the reason why such an effect is speculated as follows. First, Zr and Ti can be combined with an amorphous matrix framework (for example, SiO₂) in the form of an amorphous oxide (ZrO₂, TiO₂). Here, since these ZrO₂ and TiO₂ have very high chemical resistance, they remain and form a coating after other components are eluted from the amorphous matrix due to exposure to chemicals. Therefore, it is possible to prevent damage to the amorphous region 34 from progressing. Here, in order to appropriately exhibit the chemical resistance improvement effect of Zr and Ti, the sum of the Zr mass concentration C_{Zr} and the Ti mass concentration C_{Ti} in FESEM-EDS analysis of the surface of the decorative film 30 is preferably 0.01% or more, more preferably 0.02% or more, and particularly preferably 0.03% or more. On the other hand, in consideration of a possibility of incorporating other matrix-forming elements, the sum of the Zr mass concentration C_{Zr} and the Ti mass concentration C_{Ti} is preferably 5% or less, more preferably 4% or less, still more preferably 3% or less, and particularly preferably 2% or less.

In addition, the matrix-forming element may contain bismuth (Bi). Bi diffuses into the underlying layer as Bi ions and acts as network-modifying ions on the amorphous matrix framework. Since such Bi₂O₃ has an effect of softening the amorphous region 34, it is possible to improve fixability of the decorative film 30 in the ceramic product 1. Particularly, as in the present embodiment, when the decorative film 30 is formed on the surface of the coat layer 20, even better fixability can be obtained by diffusing Bi₂O₃ toward the coat layer 20. That is, Bi can contribute to preventing damage to (peeling off of) the decorative film 30 by improving fixability. In addition, as described above, since Bi diffuses as network-modifying ions, the crystalline particles 35 to be described below are unlikely to be formed. Here, in order to appropriately exhibit the fixing property improvement effect of Bi, in FESEM-EDS analysis of the surface of the decorative film 30, the Bi mass concentration C_{Bi} is preferably 0.01% or more, more preferably 0.015% or more, and particularly preferably 0.05% or more. In addition, in consideration of a possibility of incorporating other matrix-forming elements, the Bi mass concentration C_{Bi} is preferably 5% or less, more preferably 4.7% or less, still more preferably 4.5% or less, and particularly preferably 4% or less.

In addition, other preferable examples of matrix-forming elements other than Si include rare earth elements. The rare earth elements can be selected from among scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu) without particular limitations. Since these rare earth elements have a high affinity for oxygen, they can tighten the amorphous matrix and can prevent alkaline components from entering. In addition, like the above Ti and Zr, since oxides of rare earth elements also remain and form a coating after other components are eluted, it is possible to prevent the progress of damage to the amorphous region 34 due to exposure to chemicals. Here, in order to appropriately exhibit the effect of improving chemical resistance (particularly alkali resistance) by rare earth elements, the mass concentration C_{R} of rare earth elements is preferably 0.3% or more, more preferably 0.4% or more, and particularly preferably 0.5% or more. On the other hand, in consideration of a possibility of incorporating other matrix-forming elements, the mass concentration C_{R} of rare earth elements is preferably 7.5% or less, more preferably 6.0% or less, and particularly preferably 5.5% or less.

Other preferable examples of matrix-forming elements include cobalt (Co). This Co can also be combined with an amorphous matrix framework (for example, SiO₂) in the form of an amorphous oxide (at least one of CoO, Co₃O₄, and Co₂O₃). Here, this cobalt oxide can contribute to improving chemical resistance of the decorative film 30 by strengthening the adhesion between the noble metal region 32 and the amorphous region 34.

Here, the amorphous region 34 in the present embodiment may contain an element other than matrix-forming elements. For example, the amorphous region 34 may contain the above noble metal elements or non-metal elements such as carbon (C) and oxygen (O). Here, some of noble metal elements that form the noble metal region 32 are elements (such as Ag) that form amorphous oxides during a firing treatment and constitute a part of the amorphous matrix. However, in this specification, for convenience of explanation, elements listed as the above noble metal elements are not regarded as matrix-forming elements.

### (3) Crystalline Particles

As shown in FIG. 1, in the ceramic product 1 according to the present embodiment, the crystalline particles 35 are dispersed in the amorphous region 34 of the decorative film 30. Such crystalline particles 35 contain a crystalline oxide of at least one metal element selected from among the above matrix-forming elements as a main component. Since the crystalline particles 35 are formed of a crystalline oxide, they have a structural characteristic that alkaline components are less likely to penetrate them than the amorphous region 34. Therefore, when the crystalline particles 35 are dispersed in the amorphous region 34, it is possible to prevent the alkaline components from entering the amorphous region 34 and it is possible to reduce damage to the decorative film 30 during washing with an alkali. Here, in this specification, “crystalline particles containing a crystalline oxide as a main component” refers to a region in which a peak indicating a crystalline oxide is confirmed in X-ray diffraction measurement (XRD) of a decorative film.

Here, as described above, the crystalline particles 35 reduce damage to the decorative film 30 during washing with an alkali due to their structural characteristics that alkaline components are less likely to penetrate. Therefore, the crystalline particles 35 may be formed of a crystalline oxide of matrix-forming elements that can be dispersed in the amorphous region 34. That is, specific constituent metal elements of the crystalline particles 35 are not particularly limited as long as they are the above matrix-forming elements. However, in order to reduce damage to the decorative film 30 more suitably, it is preferable that the crystalline particles 35 contain a crystalline oxide of a metal cation having an ion potential of 2.5 or more and 12 or less as a main component. The ion potential is a parameter obtained by dividing the ionic charge by the ionic radius and is an index of the bond strength of a cation to an anion. The crystalline oxide of a metal cation having an ion potential of 2.5 or more has a characteristic of a strong bond with oxygen atoms and high water resistance. On the other hand, the crystalline oxide of a metal cation having an ion potential of 12 or less has high alkali resistance because it has low reactivity with an alkali. That is, when the crystalline particles 35 are formed of a crystalline oxide having the above ion potential, it is possible to obtain a decorative film that achieves both alkali resistance and water resistance at a high level. Here, in order to obtain higher water resistance, the ion potential is more preferably 3 or more and still more preferably 3.5 or more. On the other hand, in order to obtain higher alkali resistance, the ion potential is more preferably 10 or less and still more preferably 8 or less. Here, as an example of a crystalline oxide having such an ion potential, a crystalline oxide containing Zr and/or Ti may be exemplified. As described above, among oxides of various matrix-forming elements, oxides of Zr and Ti have very high chemical resistance as individual materials. Therefore, when crystalline oxides of Zr and Ti are dispersed in the amorphous region 34, it is particularly suitably possible to prevent the decorative film 30 from being peeled off during washing with an alkali. Here, crystalline oxides of Zr and Ti may be not only ZrO₂ and TiO₂ but also composite oxides such as ZrTiO₄ and Ti₂Bi₂O₇. It is confirmed that these composite oxides also have suitable chemical resistance (alkali resistance).

Here, the matrix-forming elements that form the crystalline particles 35 may or may not be included in the amorphous matrix of the amorphous region 34. For example, when the crystalline particles 35 containing ZrO₂ are formed, the amorphous matrix of the amorphous region 34 may or may not contain ZrO₂. Such points do not significantly affect the effects obtained by the technology disclosed here. In addition, in the amorphous region 34 of the decorative film 30 in the present embodiment, a plurality of types of crystalline particles 35 having different main components may be dispersed. For example, it is confirmed that it is suitably possible to prevent the decorative film 30 from being peeled off even when two types of the crystalline particles 35 containing ZrO₂ and the crystalline particles 35 containing ZrTiO₄ are dispersed in the amorphous region 34.

In addition, the shape of the crystalline particles 35 is not a factor that limits the technology disclosed here. For example, the crystalline particles 35 may be dispersed in the amorphous region 34 in the form of independent primary particles or may be dispersed in the amorphous region 34 in the form of secondary particles in which necks are formed between a plurality of primary particles. Here, the crystallite diameter of the crystalline particles 35 (particle size of primary particles) is preferably 1 nm or more, more preferably 2 nm or more, and still more preferably 2.5 nm or more. When such sufficiently large crystalline particles 35 are dispersed in the amorphous region 34, it is more suitably possible to prevent alkaline components from entering the amorphous region 34. On the other hand, when the crystalline particles 35 become too large, light that has entered the amorphous region 34 may be scattered by the crystalline particles 35 and thus may adversely affect color development of the decorative film 30. In consideration of this, the crystallite diameter of the crystalline particles 35 is preferably 20 nm or less, more preferably 15 nm or less, and still more preferably 10 nm or less. Here, the above crystallite diameter of the crystalline particles 35 is calculated based on the peak half-value width in XRD analysis of the decorative film 30.

### <Method of Producing Ceramic Product>

Next, an example of a method of producing the ceramic product 1 according to the present embodiment will be described. Here, the ceramic product disclosed here is not limited to those produced by the following production method.

### 1. Preparation of Substrate

When the ceramic product 1 according to the present embodiment is produced, first, the desired substrate 10 is prepared. For example, the substrate 10 can be produced by molding and firing a substrate material obtained by kneading a predetermined ceramic material. In addition, the substrate 10 with the coat layer 20 shown in FIG. 1 can be produced by applying a glaze to the surface of the fired substrate 10 and then firing it again. However, this process is not particularly limited as long as the substrate 10 can be prepared. For example, a separately produced substrate 10 may be purchased and prepared.

### 2. Formation of Decorative Film

Next, when the ceramic product 1 according to the present embodiment is produced, the decorative film 30 is formed on the substrate 10. When the decorative film 30 is formed, a desired pattern is drawn on the surface of the substrate 10 using a paste-like decorative composition (paint) containing predetermined components, and a firing treatment is then performed. In the firing treatment in this process, the firing temperature T_{F} is preferably set to be within a range of 700° C. to 1,000° C. Therefore, the decorative film 30 can be formed by sufficiently firing respective components contained in the decorative composition. The components of the decorative composition used in this process will be described below.

### (1) Noble Metal Organic Compound

The decorative composition in the present embodiment contains a noble metal organic compound as a precursor of the noble metal region 32. The noble metal organic compound is a compound of a noble metal element and an organic substance. When such a noble metal organic compound is fired, the organic substance is burned, the noble metal is then sintered, and the noble metal region 32 is formed. Here, the noble metal organic compound may have the form of a metal resinate, a complex, a polymer or the like. In addition, details of the elements that can be used as noble metal elements will be omitted because explanations are redundant. On the other hand, the organic substance is particularly limited as long as the effects of the technology disclosed here are not significantly impaired, and conventionally known resin materials that can be used to produce metal organic compounds can be used without particular limitations. Examples of such resin materials include carboxylic acids with a large number of carbon atoms (for example, 8 or more carbon atoms) such as octylic acid (2-ethylhexanoic acid), abietic acid, naphthenic acid, stearic acid, oleic acid, linolenic acid, and neodecanoic acid; sulfonic acid; resin acids contained in rosin or the like; resin sulfurized balsam containing an essential oil component such as turpentine oil and lavender oil, alkyl mercaptide (alkyl thiolate), aryl mercaptide (aryl thiolate), mercaptocarboxylic acid ester, and alkoxide.

Here, when a total number of moles of noble metal elements and matrix-forming elements in the decorative composition before firing is 100 mol %, the content of the noble metal element is preferably 25 mol % or more, more preferably 30 mol % or more, still more preferably 35 mol % or more, and particularly preferably 40 mol % or more. In this manner, when the decorative composition containing a certain amount or more of noble metal elements is fired, the sufficient noble metal region 32 is produced, and thus the decorative film 30 having excellent color development and chemical resistance can be formed. On the other hand, the upper limit of the content of the noble metal element is preferably 85 mol % or less, more preferably 80 mol % or less, still more preferably 75 mol % or less, and particularly preferably 70 mol % or less. Therefore, because the content of the matrix-forming metal-organic compound, which is a precursor of the amorphous region 34, can be secured at a certain level or more, the decorative film 30 having sufficient fixation to the substrate can be easily formed. In addition, as the content of the noble metal element is reduced, the decorative film 30 that prevents the occurrence of sparks when using a microwave oven tends to be formed easily.

### (2) Matrix-Forming Metal-Organic Compound

Next, the decorative composition in the present embodiment contains a matrix-forming metal-organic compound. The matrix-forming metal-organic compound is a compound of the above matrix-forming element and an organic substance. The organic substance used in such a matrix-forming metal-organic compound is not particularly limited as long as the effects of the technology disclosed here are not significantly impaired, and the same organic substance used in the above noble metal organic compound can also be used. When such a matrix-forming metal-organic compound is fired, the organic substance is burned, the matrix-forming element is then oxidized, and the amorphous region 34 is formed.

Here, in the decorative composition according to the present embodiment, the matrix-forming metal-organic compound is prepared so that the crystalline particles 35 are dispersed in the amorphous region 34 after firing.

Specifically, the matrix-forming metal-organic compound in the present embodiment includes at least a Si organic compound and a crystal-forming organic compound. The Si organic compound is a compound of silicon (Si) and an organic substance. When such a Si organic compound is fired, the organic substance is burned and Si is oxidized to form SiO₂. Here, such SiO₂ constructs an amorphous matrix framework and becomes a main component of the amorphous region 34. On the other hand, the crystal-forming organic compound is a compound of a crystal-forming element that is a main component of the crystalline particles 35, and an organic substance. In this specification, “crystal-forming element” is a matrix-forming element with a single bond strength of less than 339 kJ/mol when an oxide is formed. Since this type of metal oxide with a weak single bond strength has weak covalent bonding, it cannot independently form an amorphous matrix framework and becomes crystalline particles. Here, in this specification, “single bond strength” is a value measured according to the measurement method disclosed in K. H. Sun. J. Am. Ceram Soc., 30, 277 (1947). Specifically, the single bond strength is a value obtained by dividing the value of dissociation energy of MO_{n/M} into gaseous atoms in a single metal oxide (MₘOₙ, M is a metal element) by the coordination number of oxygen in the metal element.

Here, the decorative composition in the present embodiment is prepared so that the relationship between the burning temperature T_{Si} of the Si organic compound and the burning temperature T_{X} of the crystal-forming organic compound satisfies the following Formula (1). When a decorative composition having such a structure is fired, the crystal-forming organic compound having a relatively low burning temperature is preferentially decomposed and fired, and an oxide of the crystal-forming element is produced. As described above, the oxide of the crystal-forming element with a single bond strength of less than 339 kJ/mol cannot independently form an amorphous matrix framework, and thus it is produced in the form of the crystalline particles 35. Thus, after the crystalline particles 35 is formed, the Si organic compound is decomposed and fired, and an amorphous matrix framework of the amorphous region 34 is formed. In this manner, if the amorphous matrix is formed when the crystalline particles 35 are present, the decorative film 30 in which the crystalline particles 35 are dispersed in the amorphous region 34 can be formed.

$${T}_{X} < {T}_{Si} \qquad ( 1 )$$

Here, as shown in Formula (1), the crystal-forming organic compound is configured such that the burning temperature T_{X} is lower than the burning temperature T_{Si} of the Si organic compound. Here, the burning temperature of the metal organic compound can be easily adjusted by changing the type of the organic substance that combines with the metal element. That is, the crystal-forming organic compound can be obtained by selecting a predetermined crystal-forming element and appropriately selecting the type of the organic substance so that it burns at a temperature lower than the burning temperature T_{Si} of the Si organic compound. In addition, as described above, the crystal-forming element is a metal element with a single bond strength of less than 339 kJ/mol when an oxide is formed. Examples of such crystal-forming elements include Ga₂O₃, Li₂O, CaO, Sc₂O₃, TiO₂, V₂O₅, ZnO, Y₂O₃, ZrO₂, In₂O₃, SnO₂, TeO₂, La₂O₃, Na₂O, K₂O, Rb₂O, Cs₂O, SrO, SrO, and CdO. The following Table 1 shows the single bond strength of oxides of these crystal-forming elements. Here, among the above elements, Ti and Zr are particularly preferable as crystal-forming elements. As described above, since the crystalline particles 35 containing Ti and Zr are unlikely to dissolve in an alkaline solution, it is more suitably possible to prevent the decorative film 30 from being peeled off during washing with an alkali.

TABLE 1

| | Single bond | | Single bond | | Single bond |
|---|---|---|---|---|---|
| Oxide | strength | Oxide | strength | Oxide | strength |
| name | (kJ/mol) | name | (kJ/mol) | name | (kJ/mol) |
| Ga₂O₃ | 279 | Y₂O₃ | 209 | K₂O | 50 |
| Li₂O | 150 | ZrO₂ | 255 | Rb₂O | 42 |
| CaO | 133 | In₂O₃ | 180 | Cs₂O | 134 |
| Sc₂O₃ | 251 | SnO₂ | 192 | SrO | 138 |
| TiO₂ | 305 | TeO₂ | 285 | SrO | 84 |
| V₂O₅ | 313 | La₂O₃ | 243 | CdO | 101 |
| ZnO | 151 | Na₂O | 54 | | |

Here, the content of the crystal-forming element based on 100 mol % of a total number of moles of all matrix-forming elements contained in the decorative composition is preferably 3 mol % or more, preferably 4 mol % or more, preferably 4.5 mol % or more, or preferably 5 mol % or more. Therefore, the decorative film 30 in which a sufficient amount of the crystalline particles 35 are dispersed can be formed. On the other hand, in order to sufficiently form the amorphous region 34, the content of the crystal-forming element in the matrix-forming element is preferably 60 mol % or less, more preferably 55 mol % or less, still more preferably 50 mol % or less, and particularly preferably 40 mol % or less.

In addition, the burning temperature of each metal organic compound is not particularly limited as long as it satisfies the above Formula (1). However, in order to reduce quality deterioration due to the residual organic substance, the burning temperature of each metal organic compound is preferably lower than the above firing temperature T_{F}. For example, when the firing temperature T_{F} is set to 800° C., the burning temperature T_{Si} of the Si organic compound is preferably 600° C. to 750° C., more preferably 625° C. to 725° C. or lower, and still more preferably 650° C. or higher and 700° C. or lower. In this case, the burning temperature T_{X} of the crystal-forming organic compound is preferably 450° C. to 560° C., more preferably 460° C. to 550° C., and still more preferably 470° C. to 540° C. in order to satisfy Formula (1) and appropriately form the crystalline particles 35.

Here, among the above matrix-forming metal-organic compounds, those that burn at a temperature higher than that of the Si organic compound form an amorphous matrix of the amorphous region 34 together with SiO₂. That is, when an amorphous matrix containing an element other than Si is formed, it is preferable to add the matrix-forming metal-organic compound having a higher burning temperature than that of the Si organic compound to the decorative composition. Examples of such matrix-forming metal-organic compounds include an Al organic compound that is a compound of Al and an organic substance. When the Si organic compound and the Al organic compound are fired at the same time, the amorphous region 34 containing aluminosilicate glass, which contains a composite oxide of Si and Al as an amorphous matrix, is formed. According to the technology disclosed here, even if the amorphous region 34 containing such aluminosilicate glass is formed, when the crystalline particles 35 are dispersed in the amorphous region 34, it is possible to prevent the decorative film from peeling off during washing with an alkali. Here, in order to appropriately form an amorphous region containing aluminosilicate glass, a total content of Si and Al in the decorative composition is preferably 5 mol % or more, more preferably 10 mol % or more, and particularly preferably 15 mol % or more. On the other hand, in consideration of a possibility of adding other components, the upper limit of the total content of Si and Al is preferably 60 mol % or less, more preferably 55 mol % or less, and still more preferably 50 mol % or less. In addition, in order to more appropriately form aluminosilicate glass, the content of Si based on a total number of moles of Si and Al of 100 mol % is preferably 40 mol % or more, more preferably 50 mol % or more, still more preferably 60 mol % or more, and particularly preferably 70 mol % or more. On the other hand, when the content of Si with respect to the total number of moles of Si and Al is 99.5 mol % or less (that is, the content of Al is 0.5 mol % or more), since a sufficient amount of Al is present, it is possible to form an amorphous region containing aluminosilicate glass.

In addition, as described above, bismuth (Bi) is another preferable example of matrix-forming elements. Bi may also be added to the decorative composition in the form of a Bi organic compound. Here, in order to appropriately form the decorative film 30 in which the fixing property improvement effect of Bi is appropriately exhibited, the content of Bi based on 100 mol % of a total number of moles of matrix-forming elements is preferably 5 mol % or more, more preferably 6 mol % or more, still more preferably 7 mol % or more, and particularly preferably 8 mol % or more. On the other hand, in consideration of a possibility of adding other components, the upper limit of the Bi content in the matrix-forming element is preferably 30 mol % or less, more preferably 25 mol % or less, and still more preferably 20 mol % or less.

### (3) Other Components

In addition, the decorative composition may contain another additional components as long as the effects of the technology disclosed here are not significantly impaired. As an example of such an additional component, an organic solvent in which a metal organic compound is dispersed or dissolved may be exemplified. When an organic solvent is added to adjust the viscosity of the decorative composition, it is easy to form the decorative film 30 exhibiting a desired pattern (including letters and pictures). Here, as the organic solvent, as long as the effects of the technology disclosed here are not significantly impaired, organic solvents that are used in conventionally known resinate pastes and gold liquids can be used without particular limitations. Examples of organic solvents that can be used in the present embodiment include 1,4-dioxane, 1,8-cineole, 2-pyrrolidone, 2-phenylethanol, N-methyl-2-pyrrolidone, p-tolualdehyde, benzyl benzoate, butyl benzoate, eugenol, caprolactone, geraniol, methyl salicylate, cyclohexanone, cyclohexanol, cyclopentyl methyl ether, citronellal, di(2-chloroethyl)ether, diethylene glycol monomethyl ether, diethylene glycol monobutyl ether, dihydrocarbon, dibromomethane, dimethyl sulfoxide, dimethylformamide, nitrobenzene, pyrrolidone, propylene glycol monophenyl ether, pulegone, benzyl acetate, benzyl alcohol, benzaldehyde, turpentine oil, and lavender oil. Here, these organic solvents may be used alone or two or more thereof may be used. In addition, for example, since the metal organic compound is commercially available in the form of a paste, a decorative composition obtained by mixing various pastes without change can also be prepared.

In addition, the decorative composition may contain additional components other than the organic solvent as long as the effects of the technology disclosed here are not significantly impaired. Examples of such additional components include an organic binder, a protective material, a surfactant, a thickener, a pH adjuster, a preservative, an antifoaming agent, a plasticizer, a stabilizer, and an antioxidant.

### OTHER EMBODIMENTS

One embodiment of the technology disclosed here has been described above. Here, the above embodiment is an example in which the technology disclosed here is applied, and does not limit the technology disclosed here.

For example, as shown in FIG. 1, the ceramic product 1 according to the above embodiment has the coat layer 20 between the substrate 10 and the decorative film 30. However, in the ceramic product disclosed here, the coat layer 20 is not an essential structure. That is, the decorative film may be formed directly on the surface of the ceramic substrate. According to the technology disclosed here, also in the ceramic product in which the decorative film is formed directly on the surface of the substrate, a decorative film having sufficient chemical resistance can be formed.

In addition, as shown in FIG. 1, the ceramic product 1 according to the above embodiment is a microwaveable ceramic product in which a plurality of noble metal regions 32 are scattered in the amorphous region 34. However, according to the technology disclosed here, also in the ceramic product other than those compatible with microwaveables, it is suitably possible to prevent the decorative film from peeling off during washing with an alkali.

In addition, in the decorative composition according to the above embodiment, in order to form the decorative film 30 in which the crystalline particles 35 are dispersed in the amorphous region 34, the burning temperature T_{X} of the crystal-forming organic compound is adjusted to be lower than the burning temperature T_{Si} of the Si organic compound (T_{X}<T_{Si}). However, in the technology disclosed here, it is only necessary to form a decorative film in which crystalline particles are dispersed in an amorphous region, and the composition for forming the decorative film is not limited to the decorative composition in the above embodiment. For example, even when the crystalline particles formed in advance are dispersed in the decorative composition, it is possible to form a decorative film in which crystalline particles are dispersed in an amorphous region. Specifically, when crystalline particles formed in advance are dispersed in the decorative composition, since an amorphous matrix framework of the amorphous region can be formed in the presence of crystalline particles, it is possible to appropriately form the decorative film 30 in which the crystalline particles 35 are dispersed in the amorphous region 34. Unlike the decorative composition according to the above embodiment, the decorative composition in which such crystalline particles are dispersed has an advantage that the Si organic compound can be selected without considering the burning temperature T_{Si}. In addition, according to the present embodiment, it is also possible to form the crystalline particles 35 containing elements (for example, Si and Al) that have high single bond strength and easily form an amorphous matrix.

### Test Examples

Test examples related to the technology disclosed here will be described below, but the technology disclosed here is not intended to be limited to such test examples.

### <Preparation of Decorative Composition>

In this test, 22 types of decorative compositions having different formulations were prepared (Example 1 to Example 22). Table 2 shows formulations of the decorative compositions in respective examples. Here, each numerical value in Table 2 is the content (mol %) of each element based on 100 mol % of a total number of moles of noble metal elements and matrix-forming elements contained in the decorative composition (in other words, a total number of moles of metal elements and semi-metal elements). In addition, when the decorative composition of each example was prepared, various raw materials were mixed in an ointment pot, and mixed using a stirrer (product name: Rotation and Revolution Thinky Mixer, commercially available from Thinky Corporation) at a rotational speed of 1,800 rpm for 2 minutes.

TABLE 2

| | Content based on 100 mol % of a total number of moles of | | | | | | | | | | | | | |
|---|---|---|---|---|---|---|---|---|---|---|---|---|---|---|
| | noble metal elements and matrix-forming elements (mol %) | | | | | | | | | | | | | |
| | Noble metal element | | | | | Matrix-forming element | | | | | | | | |
| | Au | Pt | Rh | Pd | Sum | Al | Si-1 | Si-2 | Bi | Ti-1 | Ti-2 | Ti-3 | Zr-1 | Zr-2 |
| Example 1 | 41.60 | 5.30 | | 9.60 | 56.50 | | 36.50 | | 4.20 | | | | | 2.80 |
| Example 2 | 26.08 | 28.52 | 2.40 | | 56.99 | | 34.94 | | 4.24 | | | | 3.83 | |
| Example 3 | 3.01 | 57.77 | 0.66 | | 61.43 | 0.27 | 28.78 | | 3.49 | | | | 6.03 | |
| Example 4 | | 59.40 | 0.60 | | 60.00 | 0.30 | | 32.20 | 3.90 | | | | | 3.50 |
| Example 5 | 2.89 | 55.61 | 0.63 | | 59.13 | 0.33 | 34.46 | | 4.18 | | | | 1.90 | |
| Example 6 | 3.06 | 58.97 | 0.67 | | 62.70 | 0.24 | 25.55 | | 3.10 | | | | 8.40 | |
| Example 7 | | 70.08 | | | 70.08 | 1.26 | 14.21 | | 5.72 | | | | 8.73 | |
| Example 8 | | 74.40 | | | 74.40 | 2.03 | 4.70 | | 5.07 | | | | 13.79 | |
| Example 9 | 2.93 | 56.34 | 0.65 | | 59.92 | 0.28 | 29.82 | | 3.62 | 3.09 | | | 3.27 | |
| Example 10 | 2.91 | 55.87 | 0.64 | | 59.41 | 0.30 | 32.09 | | 3.89 | 1.67 | | | 2.64 | |
| Example 11 | 2.86 | 54.98 | 0.63 | | 58.47 | 0.30 | 31.58 | | 3.83 | 4.96 | | | 0.86 | |
| Example 12 | 2.84 | 54.56 | 0.62 | | 58.02 | 0.30 | 31.34 | | 3.80 | | 6.55 | | | |
| Example 13 | 2.75 | 52.83 | 0.60 | | 56.18 | 0.29 | 30.35 | | 3.68 | | | 9.51 | | |
| Example 14 | | 82.41 | 1.12 | | 83.52 | 0.09 | 13.30 | | 1.62 | | | | 1.47 | |
| Example 15 | 2.16 | 41.66 | 0.47 | | 44.29 | 0.40 | 44.93 | | 5.45 | | | | 4.93 | |
| Example 16 | 3.44 | 66.14 | 0.76 | | 70.33 | 0.33 | 17.96 | | 7.24 | | | | 4.14 | |
| Example 17 | 2.98 | 57.24 | 0.65 | | 60.87 | 0.29 | 31.08 | | 4.18 | | | | 3.58 | |
| Example 18 | | 53.17 | 0.58 | | 53.74 | 17.94 | 17.94 | | 6.47 | | | | 3.90 | |
| Example 19 | 30.11 | | 0.21 | | 30.32 | 0.49 | 56.21 | | 6.81 | | | | 6.17 | |
| Example 20 | 2.80 | 54.60 | 0.60 | | 58.00 | 0.40 | 37.10 | | 4.50 | | | | | |
| Example 21 | | 53.30 | 0.70 | | 54.00 | | 41.70 | | 4.30 | | | | | |
| Example 22 | | 59.40 | 0.60 | | 60.00 | 0.30 | | 32.20 | 3.90 | | | | 3.50 | |

| | Content based on 100 mol % | | | | | |
|---|---|---|---|---|---|---|
| | of a total number of moles of | | | | | |
| | noble metal elements and | | Content based on 100 mol % | | | |
| | matrix-forming elements (mol %) | | of a total number of moles | | | |
| | Matrix-forming element | | of matrix-forming elements (mol %) | | | |
| | | Total amount of | | Total amount of | | |
| | | crystal- | | crystalline | | |
| | Total amount of | forming metal | Total amount of | oxide- | | Si/ |
| | Si and Al | elements | Si and Al | forming elements | Bi | (Si + Al) |
| Example 1 | 36.50 | 2.80 | 83.91 | 6.44 | 9.66 | 100.00 |
| Example 2 | 34.94 | 3.83 | 81.24 | 8.91 | 9.85 | 100.00 |
| Example 3 | 29.05 | 6.03 | 75.32 | 15.63 | 9.05 | 99.06 |
| Example 4 | 32.50 | 3.50 | 81.45 | 8.77 | 9.77 | 99.08 |
| Example 5 | 34.79 | 1.90 | 85.12 | 4.65 | 10.23 | 99.06 |
| Example 6 | 25.79 | 8.40 | 69.16 | 22.53 | 8.31 | 99.06 |
| Example 7 | 15.47 | 8.73 | 51.69 | 29.19 | 19.12 | 91.87 |
| Example 8 | 6.74 | 13.79 | 26.32 | 53.86 | 19.82 | 69.80 |
| Example 9 | 30.10 | 6.36 | 75.10 | 15.88 | 9.02 | 99.06 |
| Example 10 | 32.39 | 4.31 | 79.80 | 10.62 | 9.59 | 99.06 |
| Example 11 | 31.88 | 5.82 | 76.76 | 14.01 | 9.23 | 99.06 |
| Example 12 | 31.63 | 6.55 | 75.35 | 15.59 | 9.06 | 99.06 |
| Example 13 | 30.63 | 9.51 | 69.90 | 21.70 | 8.40 | 99.06 |
| Example 14 | 13.39 | 1.47 | 81.27 | 8.92 | 9.81 | 99.34 |
| Example 15 | 45.34 | 4.93 | 81.38 | 8.84 | 9.78 | 99.11 |
| Example 16 | 18.28 | 4.14 | 61.64 | 13.96 | 24.41 | 98.20 |
| Example 17 | 31.36 | 3.58 | 80.16 | 9.16 | 10.68 | 99.09 |
| Example 18 | 35.89 | 3.90 | 77.58 | 8.44 | 13.98 | 50.00 |
| Example 19 | 56.70 | 6.17 | 81.37 | 8.85 | 9.77 | 99.13 |
| Example 20 | 37.50 | — | 89.29 | 0.00 | 10.71 | 98.93 |
| Example 21 | 41.70 | — | 90.65 | 0.00 | 9.35 | 100.00 |
| Example 22 | 32.50 | 3.50 | 81.45 | 8.77 | 9.77 | 99.08 |

Here, as shown in Table 2, in this test, as the matrix-forming elements contained in the decorative composition, Al, Si, Bi, Ti, and Zr were selected. As described above, since the single bond strength of Ti and Zr was less than 339 kJ/mol when an oxide was formed, crystalline particles were obtained as crystal-forming elements. On the other hand, Al and Si had a single bond strength of 339 kJ/mol or more when an oxide was formed, and were not crystal-forming elements because they could independently form an amorphous matrix. Specifically, the single bond strength of Al₂O₃ was 377 kJ/mol, and the single bond strength of SiO₂ was 443 kJ/mol.

In addition, the elements in the above Table 2 were added to the decorative composition in the following form. Here, regarding Si, two types of Si organic compounds (Si-1 and Si-2) with different burning temperatures T_{Si} were used. In addition, regarding Ti, two types of Ti organic compounds with different burning temperatures T_{Ti} (Ti-1 and Ti-2), and titanium oxide (TiO₂) nanoparticles (Ti-3) were used. Here, regarding Zr, a Zr organic compound (Zr-1) and zirconium oxide (ZrO₂) nanoparticles (Zr-2) were used. The burning temperatures of these components are also listed below.
Au: Au resinate (Au resin sulfurized balsam)
Pt: Pt resinate (Pt resin sulfurized balsam)
Rh: Rh resinate (Rh resin sulfurized balsam)
Pd: Pd resinate (Pd resin sulfurized balsam)
Al: Al resinate (Al resinate, burning temperature T_{Al}: 583.1° C.)
Si-1: Si resinate (Si resinate, burning temperature T_{Si}: 680.8° C.)
Si-2: Si resinate (Si resinate, burning temperature T_{Si}: 378.5° C.)
Bi: Bi resinate (Bi resinate, burning temperature T_{Bi}: 561.2° C.)
Ti-1: Ti resinate (Ti resinate, burning temperature T_{Ti}: 512.9° C.)
Ti-2: Ti complex (a complex having an alkoxide ligand and a diketone ligand, burning temperature T_{Ti}: 501.5° C.)
Ti-3: TiO₂ nanoparticles (average particle size: 15.8 nm)
Zr-1: Zr resinate (Zr resinate, burning temperature T_{Zr}: 532.9° C.)
Zr-2: ZrO₂ nanoparticles (average particle size: 6.8 nm)

Here, the above burning temperatures were all based on TG-DTA measurements using a thermogravimetric measurement device (TG-DTA/H, commercially available from Rigaku Corporation). Specifically, a target metal organic compound was left in an environment with an air flow rate of 300 ml/min, the temperature was raised from room temperature (20° C.) to 1,000° C. at a heating rate of 10° C./min, and the temperature at which weight loss due to burning of an organic substance no longer occurred was regarded as the burning temperature. Here, in this measurement, when the weight when the heating temperature was increased by 3° C. was within a range of 0.03% of the weight before the temperature was increased, it was determined that no weight loss occurred.

### <Production of Ceramic Product>

A white porcelain plate (length: 15 mm, width: 15 mm) with a surface to which a glaze was applied was prepared, and a decorative composition (any of Example 1 to Example 22) was applied (coated) to the entire surface of one side of the white porcelain plate. The decorative composition was applied using a spin coater (Opticoat MS-A-150, commercially available from Mikasa Corporation), and spin conditions were set to 5,000 rpm and 10 seconds. Then, the white porcelain plate coated with the decorative composition was dried on a hot plate at 60° C. for 1 hour, and then fired at 800° C. for 10 minutes. Thereby, 23 types of ceramic products in which the decorative film was formed on the surface were produced as test pieces. Here, as a result of observing the cross section of the decorative film after firing using FE-SEM (SU-8200, commercially available from Hitachi High-Tech Corporation), the film thickness of the decorative film after firing was within a range of 30 nm to 250 nm.

### 2. Evaluation Test

<Analysis of Decorative Film after Firing>

In this evaluation, the ceramic products of respective examples were observed under a TEM, and the structure of the decorative film was examined. As an example of such TEM observation results, a TEM image (800,000×) of the decorative film of Example 4 is shown in FIG. 2.

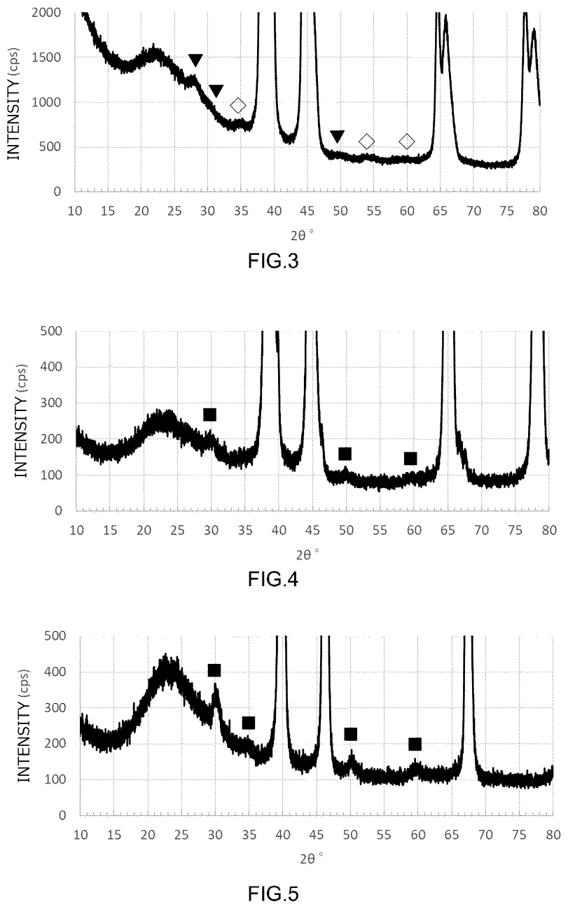

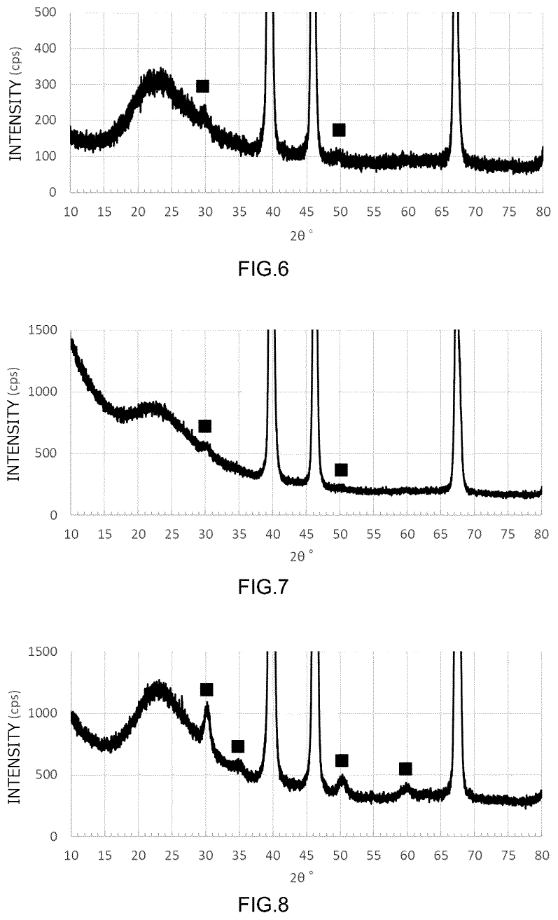

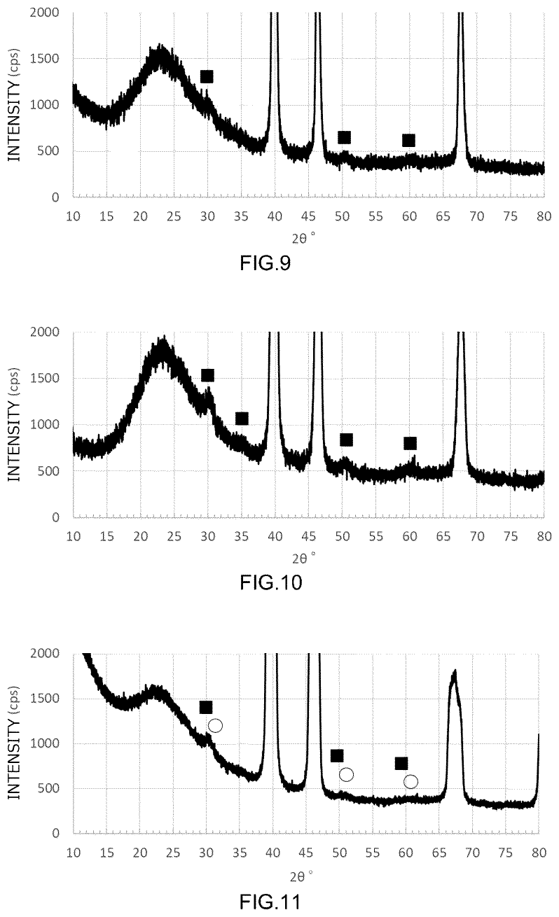

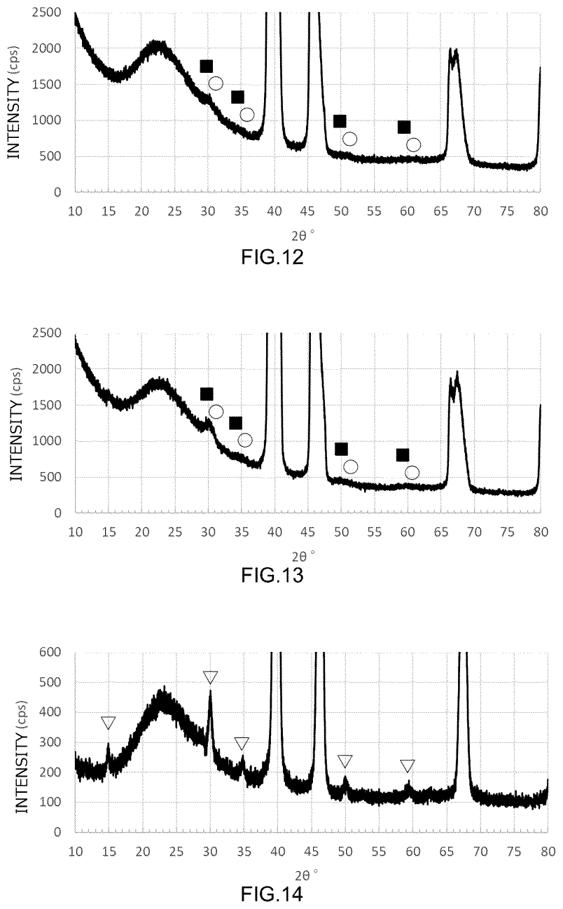

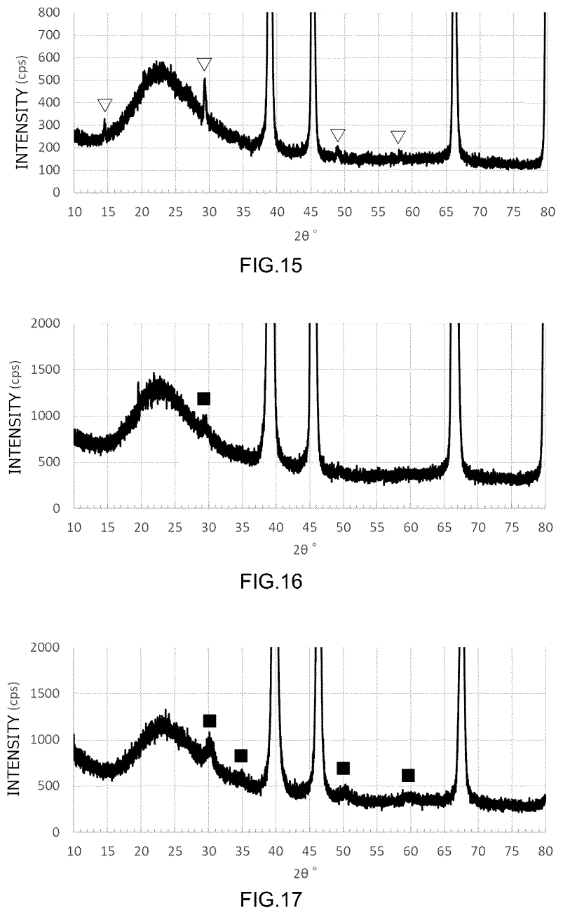

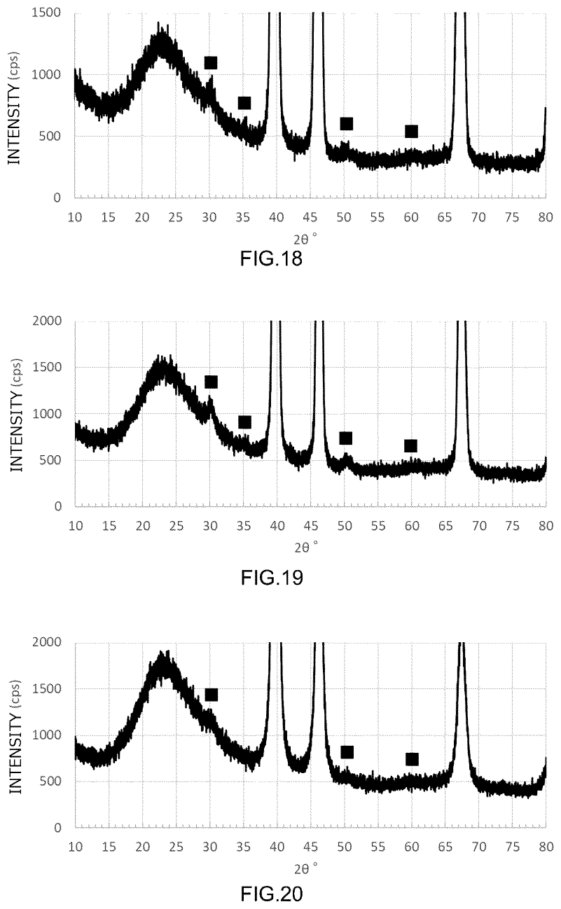

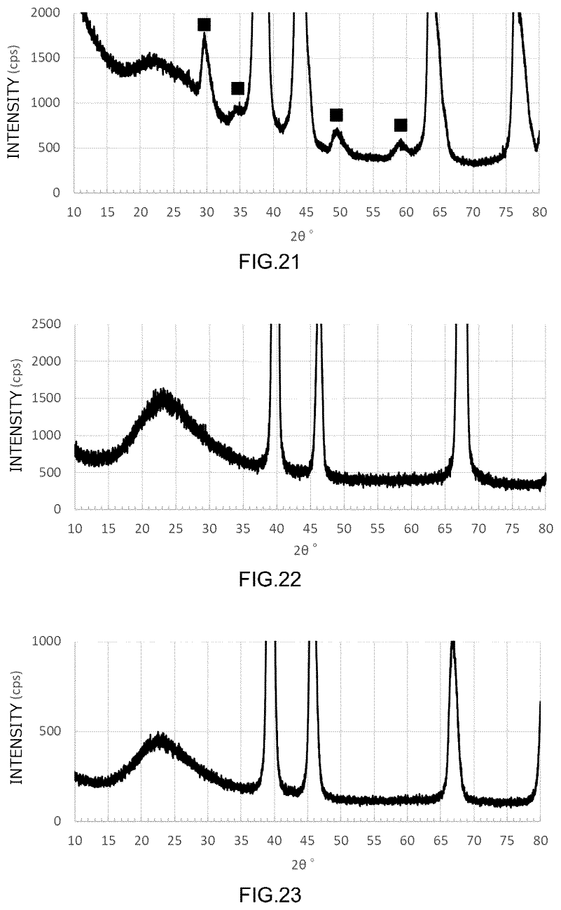

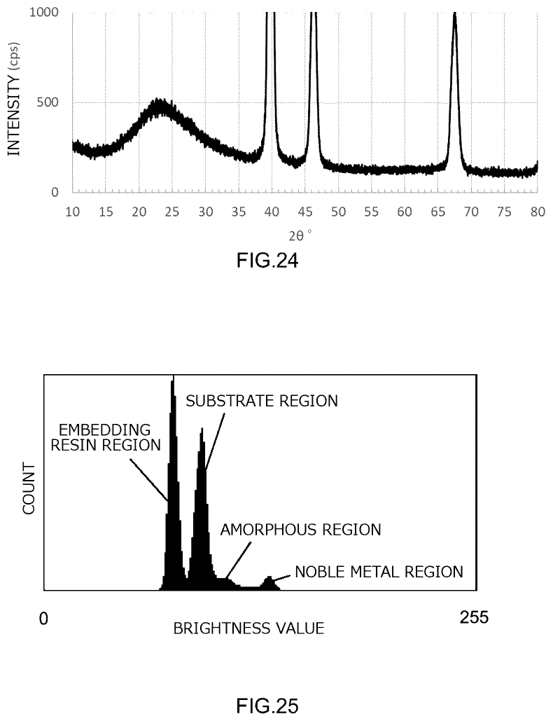

In addition, in this test, XRD (X-ray diffraction measurement) was performed on the decorative films of respective examples, and the composition of the decorative film was examined. FIG. 3 to FIG. 24 show the XRD charts of the decorative films of Example 1 to Example 22. Here, X-ray diffraction measurement conditions in this test are as follows. However, the following XRD measurement conditions do not limit the technology disclosed here. The XRD measurement conditions could be appropriately changed to conditions in which the composition of the particulate component could be appropriately detected.

### [XRD Conditions]

Measurement instrument: fully automatic multipurpose X-ray diffraction device SmartLab (commercially available from Rigaku Corporation)
Scan speed: <5.00°/min
Step width: 0.01°
Scan range: 20 (5° to 80°)
Angle of incidence: w=0.2° to 1.5°

### <Alkali Resistance Evaluation>

In this test, the test piece of each example was immersed for 30 minutes in a 0.5 wt % Na₂CO₃ aqueous solution (3 L) that was heated to 100° C. and boiled. Then, the immersed test piece was washed with water, a scratch test was performed by rubbing zircon paper 10 times, and it was observed whether the decorative film was damaged. Then, in such a scratch test, when 30% or more of the decorative film remained, it was evaluated as having appropriate alkali resistance (◯).

### <Gloss Evaluation>

The gloss value of the decorative part of each example was measured using a spectrophotometer. Specifically, using a spectrophotometer (CM-700d, commercially available from Konica Minolta Japan, Inc.), the L* value, the a* value, the b* value and the gloss value indicating 8° gloss in SCI and SCE modes were measured. Then, in this evaluation, a decorative part with a gloss value of 500 or more was evaluated as having suitable gloss.

### 3. Evaluation Results

Table 3 shows the results of the evaluation tests in Example 1 to Example 22. In addition, Table 3 also shows “the burning temperature T_{Si} of the Si organic compound” and “the burning temperature T_{X} of the crystal-forming organic compound”. Here, in the decorative compositions of Example 1, Example 4, and Example 13, since the produced crystalline oxide nanoparticles were added in place of the crystal-forming organic compound, “(nanoparticles)” was written in the column “T_{X}”. In addition, in Example 20 and Example 21, the column “T_{X}” is left blank because neither the crystal-forming element nor the produced crystalline particles were included.

TABLE 3

| | | | Crystalline | Alkali | | | | | | | |
|---|---|---|---|---|---|---|---|---|---|---|---|
| | | | oxide | resistance | Color | | | | | | |
| | T_{Si} | T_{X} | detected | test | SCI | | | SCE | | | |
| | (° C.) | (° C.) | by XRD | pass/fail | L | a | b | L | a | b | Gloss |
| Example 1 | 680.8 | (nanoparticles) | ZrO₂, PdO | ◯ | 68.30 | 2.34 | 10.00 | 15.27 | 0.05 | −1.60 | 837.39 |
| Example 2 | 680.8 | 532.9 | ZrO₂ | ◯ | 59.74 | 1.09 | 4.83 | 7.56 | 0.31 | 0.83 | 616.81 |
| Example 3 | 680.8 | 532.9 | ZrO₂ | ◯ | 75.80 | 0.18 | 9.84 | 22.22 | 3.42 | 8.96 | 1052.40 |
| Example 4 | 378.5 | (nanoparticles) | ZrO₂ | ◯ | 76.46 | 0.03 | 8.78 | 20.28 | 3.10 | 8.34 | 1087.83 |
| Example 5 | 680.8 | 532.9 | ZrO₂ | ◯ | 72.42 | 1.42 | 17.84 | 20.30 | 1.95 | 6.01 | 952.39 |
| Example 6 | 680.8 | 532.9 | ZrO₂ | ◯ | 70.32 | 2.84 | 19.60 | 18.20 | 2.57 | 8.60 | 895.06 |
| Example 7 | 680.8 | 532.9 | ZrO₂ | ◯ | 76.44 | 0.57 | 10.63 | 15.02 | 1.72 | 5.91 | 1116.50 |
| Example 8 | 680.8 | 532.9 | ZrO₂ | ◯ | 68.41 | 4.40 | 13.83 | 13.39 | 3.85 | 9.27 | 851.41 |
| Example 9 | 680.8 | 512.9 | ZrO2, | ◯ | 75.89 | 0.92 | 11.25 | 16.41 | 2.88 | 8.13 | 1090.39 |
| | | | ZrTiO4, | | | | | | | | |
| | | | etc. | | | | | | | | |
| Example 10 | 680.8 | 512.9 | ZrO2, | ◯ | 75.78 | 0.47 | 9.25 | 22.27 | 3.13 | 8.88 | 1051.03 |
| | | | ZrTiO4, | | | | | | | | |
| | | | etc. | | | | | | | | |
| Example 11 | 680.8 | 512.9 | ZrO2, | ◯ | 76.27 | 0.27 | 11.78 | 18.99 | 2.29 | 6.53 | 1091.45 |
| | | | ZrTiO4, | | | | | | | | |
| | | | etc. | | | | | | | | |
| Example 12 | 680.8 | 501.5 | Ti2Bi2O7 | ◯ | 74.36 | 0.58 | 13.48 | 22.26 | 1.81 | 5.36 | 1004.17 |
| Example 13 | 680.8 | (nanoparticles) | Ti2Bi2O7 | ◯ | 75.50 | 1.60 | 11.97 | 16.22 | 3.01 | 8.64 | 1077.38 |
| Example 14 | 680.8 | 532.9 | ZrO2 | ◯ | 68.00 | 0.30 | 7.89 | 32.48 | 1.02 | 0.82 | 703.23 |
| Example 15 | 680.8 | 532.9 | ZrO2 | ◯ | 75.89 | 0.92 | 11.25 | 16.41 | 2.88 | 8.13 | 1090.39 |
| Example 16 | 680.8 | 532.9 | ZrO2 | ◯ | 68.91 | 2.16 | 13.38 | 29.42 | 1.16 | 2.55 | 766.51 |
| Example 17 | 680.8 | 532.9 | ZrO2 | ◯ | 76.07 | 0.16 | 8.43 | 24.41 | 3.94 | 10.62 | 1045.85 |
| Example 18 | 680.8 | 532.9 | ZrO2 | ◯ | 63.15 | 5.47 | 15.57 | 18.24 | 5.35 | 13.47 | 675.35 |
| Example 19 | 680.8 | 532.9 | ZrO2 | ◯ | 58.89 | 13.67 | 31.44 | 5.88 | 4.01 | 3.21 | 627.76 |
| Example 20 | 680.8 | — | No | X | 75.61 | 0.04 | 8.04 | 25.22 | 3.45 | 9.35 | 1022.46 |
| Example 21 | 680.8 | — | No | X | 74.77 | 0.13 | 7.34 | 23.11 | 3.48 | 9.75 | 1006.23 |
| Example 22 | 378.5 | 532.9 | No | X | 75.90 | 0.02 | 4.11 | 28.96 | 4.55 | 11.57 | 997.84 |

As shown in Table 3, in Example 1 to Example 19, decorative films having appropriate alkali resistance were formed. Here, it was confirmed that crystalline particles were dispersed in these decorative films of Example 1 to Example 19. Specifically, as shown in FIG. 2, in the decorative film of Example 4, it was confirmed that very fine particles P different from those of the noble metal region N were dispersed in the amorphous region M. This was the same as in Example 1 to Example 3 and Example 5 to Example 19. Here, in the XRD charts shown in FIG. 3 to FIG. 24, in addition to very high-intensity peaks indicating the noble metal regions, small peaks indicating crystalline particles were confirmed. Accordingly, in the decorative films of Example 1 to Example 19, it was confirmed that crystalline oxides such as ZrO₂, ZrTiO₂, and Ti₂Bi₂O₇ were present. In view of the above points, it was found that, when crystalline particles were dispersed in the amorphous region, it was suitably possible to prevent the decorative film from peeling off during washing with an alkali. In addition, as shown in Table 2, it was confirmed that the decorative films in Example 1 to Example 19 had excellent gloss.

In addition, in all of Examples 2, 3, 5 to 12, 14 to 18, and 22, the crystal-forming organic compound that was a compound of a crystal-forming element (Zr and/or Ti) with a single bond strength of less than 339 kJ/mol when an oxide was formed and an organic substance was added to the decorative composition. However, in Example 22, the formation of crystalline particles was not confirmed even though the sample contained a crystal-forming organic compound. Accordingly, it was found that, in order to appropriately form crystalline particles dispersed in the amorphous region, it was necessary to set the burning temperature T_{X} of the crystal-forming organic compound to be lower than the burning temperature T_{Si} of the Si organic compound, and to independently produce a metal oxide for crystalline particles in the early stage of firing. On the other hand, as shown in Examples 1, 4, and 13, it was found that, even when a decorative composition in which fine crystalline particles were dispersed was used, a decorative film in which crystalline particles were dispersed in an amorphous region could be formed. In view of these points, it was found that, when conditions were adjusted so that an amorphous matrix framework of an amorphous region was formed in the presence of crystalline particles, a decorative film in which crystalline particles were dispersed in an amorphous region could be formed.

While specific examples of the technology disclosed here have been described above in detail, these are examples, and do not limit the scope of the claims. The technologies described in the scope of the claims include various modifications and alternations of the specific examples exemplified above.

### REFERENCE SIGNS LIST

1 Ceramic product
10 Substrate
20 Coat layer
30 Decorative film
32 Noble metal region
34 Amorphous region
35 Crystalline particles

1. A ceramic product comprising:
a ceramic substrate;
a decorative film formed on the surface of the ceramic substrate, wherein
the decorative film includes:
a noble metal region containing a noble metal element as a main component;
an amorphous region containing an amorphous oxide of matrix-forming elements containing at least Si as a main component,
wherein crystalline particles containing a crystalline oxide of at least one metal element selected from among the matrix-forming elements as a main component are dispersed in the amorphous region.

2. The ceramic product according to claim 1,
wherein the matrix-forming elements include at least one selected from the group consisting of Al, Ti, Zr, Bi, Sm, Y, La, Ce, Pr, Nd, Sm, Dy, Sn, Zn, Be, Mg, Ca, Sr, Ba, Li, Na, K, Rb, B, V, Fe, Cu, P, Sc, Pm, Eu, Gd, Tb, Ho, Er, Tm, Yb, Lu, Ni, In, Co, and Cr.

3. The ceramic product according to claim 1,
wherein the crystalline particles contain, as a main component, a crystalline oxide of a metal cation having an ion potential of 2.5 or more and 12 or less, which is obtained by dividing an ionic charge by an ionic radius.

4. The ceramic product according to claim 3,
wherein the crystalline particles contain a crystalline oxide containing Zr and/or Ti as a main component.

5. The ceramic product according to claim 1,
wherein the noble metal element is at least one selected from the group consisting of Pt, Au, Pd, Rh, Ir, and Ag.

6. The ceramic product according to claim 1,
wherein the decorative film is formed by scattering a plurality of noble metal regions in the amorphous region.

7. A decorative composition for forming a decorative film of the ceramic product according to claim 1,
the decorative composition comprising:
a noble metal organic compound that is a compound of the noble metal element and an organic substance;
a matrix-forming metal-organic compound that is a compound of the matrix-forming element and an organic substance,
wherein the matrix-forming metal-organic compounds include, at least,
a Si organic compound that is a compound of Si and an organic substance, and
a crystal-forming organic compound that is a compound of a crystal-forming element with a single bond strength of less than 339 kJ/mol when an oxide is formed and an organic substance, and
wherein the relationship between the burning temperature T_{Si} of the Si organic compound and the burning temperature T_{X} of the crystal-forming organic compound satisfies the following Formula (1):
T_{X}<T_{Si} (1).

8. The decorative composition according to claim 7,
wherein the matrix-forming metal-organic compound further includes an Al organic compound that is a compound of Al and an organic substance.

9. The decorative composition according to claim 8,
wherein the total content of Si and Al is 5 mol % or more and 60 mol % or less based on 100 mol % of a total number of moles of the noble metal element and the matrix-forming element.

10. The decorative composition according to claim 8,
wherein the content of Si is 40 mol % or more and 99.5 mol % or less based on 100 mol % of a total number of moles of Si and Al.

11. The decorative composition according to claim 7,
wherein the content of the noble metal element is 25 mol % or more and 85 mol % or less based on 100 mol % of a total number of moles of the noble metal element and the matrix-forming element.

12. The decorative composition according to claim 7,
wherein the matrix-forming metal-organic compound further includes a Bi organic compound that is a compound of Bi and an organic substance.

13. The decorative composition according to claim 12,
wherein the content of Bi is 5 mol % or more and 30 mol % or less based on 100 mol % of a total number of moles of the matrix-forming element.

14. The decorative composition according to claim 7,
wherein the content of the crystal-forming element is 3 mol % or more and 60 mol % or less based on 100 mol % of a total number of moles of the matrix-forming element.

15. The decorative composition according to claim 7,
wherein the crystal-forming element is at least one selected from the group consisting of Zr and Ti.

16. A decorative composition for forming a decorative film of the ceramic product according to claim 1, comprising:
a noble metal organic compound that is a compound of the noble metal element and an organic substance; and
a matrix-forming metal-organic compound that is a compound of the matrix-forming element and an organic substance,
wherein the matrix-forming metal-organic compound includes at least a Si organic compound that is a compound of Si and an organic substance, and
wherein crystalline particles containing a metal element crystalline oxide as a main component are dispersed.
